(19) United States
(12) Patent Application Publication
(10) Pub. No.: US 2012/0287100 A1
(43) Pub. Date: Nov. 15, 2012

(54) Liquid Crystal Display Device and Method for Driving the Same

(75) Inventors: Jong-Hoon WOO, Goyang-si (KR); Su-Seok CHOI, Goyang-si (KR); Dong-Guk KIM, Goyang-si (KR); Jae-Hyung LIM, Seoul (KR); Joong-Ha LEE, Paju-si (KR)

(73) Assignee: LG Display Co., Ltd.

(21) Appl. No.: 13/467,223

(22) Filed: May 9, 2012

(30) Foreign Application Priority Data
May 12, 2011 (KR) 10-2011-0044620

(51) Int. Cl. G09G 3/36; G09G 5/00

(52) U.S. Cl. 345/209; 345/96

(57) ABSTRACT

Disclosed is a liquid crystal display device increasing transmittance to improve brightness while employing ferroelectric liquid crystals in a half-V mode. The liquid crystal display device includes a liquid crystal panel including ferroelectric liquid crystals of a half-V mode, and a driving circuit driving a liquid crystal panel so that a first frame period, which the positive data voltages are supplied to the liquid crystal panel, becomes longer than a second frame period, which the negative data voltages are supplied to the liquid crystal panel.

This application claims the benefit of Korean Patent Application No. 10-2011-0044620, filed on May 12, 2011, which is hereby incorporated by reference as if fully set forth herein.

### BACKGROUND OF THE INVENTION

1. Field of the Invention

The present invention relates to a liquid crystal display device which increases transmittance to improve brightness while employing ferroelectric liquid crystals in a half V switching mode, and a method for driving the same.

2. Discussion of the Related Art

Recently, from among display devices, a liquid crystal display device has been most widely used due to its characteristics, such as an excellent image quality, a light weight, a thin thickness and low power consumption.

In general, a liquid crystal display device includes a pair of substrates and liquid crystals inserted into a space between the substrates. The liquid crystal is a material in an intermediate state between a liquid and a solid, and has characteristics of phase transition through proper combination of temperatures or electric fields.

As temperature is lowered, N (hereinafter, referred to as nematic)-based liquid crystals which are mainly used are transferred from an isotropic phase to a nematic (N) phase and then to a crystal phase, and F (hereinafter, referred to as ferroelectric) liquid crystals are transferred from an isotropic phase to a nematic (N*) phase and then to a smectic (SmC*) phase and becomes a crystal phase.

A twisted nematic-mode liquid crystal display (TN LCD) using nematic-based liquid crystals which are generally used may be manufactured in a thin thickness and is thus advantageous in that it is easy to carry and reduces power consumption, but is disadvantageous in that it has a narrow viewing angle and a long response time to applied voltage to cause inconvenience in reproducing a moving picture.

In order to solve these problems, ferroelectric liquid crystals are employed. Such ferroelectric liquid crystals have in-plane switching characteristics, thus being capable of implementing a wide viewing angle without a special electrode structure or a compensator film.

The ferroelectric liquid crystals have a layer structure formed by areas having the same magnetic property, and drive in-plane while rotating around a virtual cone in response to an electric field. Since such ferroelectric liquid crystals cause permanent polarization even without an external electric field, i.e., spontaneous polarization, the ferroelectric liquid crystals are rapidly rotated due to interactions between the external electric field and the spontaneous polarization when the external electric field is applied, like interaction between magnets, and thus have a shorter response time by several hundred or thousand times as compared to liquid crystals in other modes. The ferroelectric liquid crystals are divided into liquid crystals in a V switching mode and liquid crystals in a half-V switching mode according to characteristics of reacting in response to polarity of an electric field.

From among the liquid crystals in these modes, ferroelectric liquid crystal cells in the half-V switching mode have a relatively small capacitance, as compared to the V switching mode, as well as a short response time and a wide viewing angle, and is thus advantageous in displaying a moving picture and is more proper for implementing a liquid crystal display device.

However, a liquid crystal display device employing ferroelectric liquid crystals in the half-V switching mode have several problems below. The ferroelectric liquid crystals in the half-V switching mode transmit light when a positive (+) electric field is supplied to the liquid crystals, wherein the positive (+) electric field is opposite to an electric field which is supplied to the liquid crystals when an initially orientation state. The liquid crystals in the half-V switching mode do not transmit light when a negative (−) electric field is supplied to the liquid crystals, wherein the negative (−) electric filed is identical to the electric filed which is supplied to the liquid crystals when the initially orientation state. Therefore, the ferroelectric liquid crystals in the half-V switching mode are not operated in the case of negative data voltage identical to polarity used in initial orientation state and thus lower transmittance, thereby having low brightness.

### SUMMARY OF THE INVENTION

Accordingly, the present invention is directed to a liquid crystal display device and a method for driving the same that substantially obviate one or more problems due to limitations and disadvantages of the related art.

An object of the present invention is to provide a liquid crystal display device which increases transmittance to improve brightness while employing ferroelectric liquid crystals in a half-V switching mode, and a method for driving the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a liquid crystal display device includes a liquid crystal panel including ferroelectric liquid crystals of a half-V mode, a gate driver supplying scan pulses to a plurality of gate lines of the liquid crystal panel, a data driver selectively outputting positive data voltages and negative data voltages to a plurality of data lines of the liquid crystal panel, and a timing controller outputting a plurality of control signals to control the gate driver and the data driver, wherein the timing controller outputs the plurality of control signals so that a first period, which the positive data voltages are supplied to the data lines, becomes longer than a second period, which the negative data voltages are supplied to the data lines.

The gate driver may output a first scan pulse for the first period, and outputs a second scan pulse, which is set to be different from the first scan pulse, for the second period.

The gate driver may sequentially supply first scan pulses to the plurality of gate lines for the period and sequentially supplies the second scan pulses to the plurality of gate lines for the second period, wherein a pulse width of the second scan pulse is smaller than a pulse width of the first scan pulse.

The gate driver may sequentially supply the first scan pulses to the plurality of gate lines for the first period, and classify the plurality of gate lines into a plurality of gate line groups and sequentially supply the second scan pulses to the plurality of gate lines by a group unit for the second period, wherein the a pulse width of the second scan pulse is the same as a pulse width of the first scan pulse.

The data driver drives the data lines by a frame inversion method and the first period is an odd frame period and the second period is an even frame period.

The liquid crystal panel transmits light when the positive data voltages are supplied and does not transmit light when the negative data voltages are supplied.

In another aspect of the present invention, a liquid crystal display device includes a liquid crystal panel including a liquid crystal panel including ferroelectric liquid crystals of a half-V mode, and a driving circuit driving a liquid crystal panel so that a first frame period, which the positive data voltages are supplied to the liquid crystal panel, becomes longer than a second frame period, which the negative data voltages are supplied to the liquid crystal panel.

In another aspect of the present invention, a liquid crystal display device includes a liquid crystal panel including a liquid crystal panel including ferroelectric liquid crystals of a half-V mode, and a driving circuit driving a liquid crystal panel so that a first frame period becomes longer than a second frame period, wherein the driving circuit supplies data voltages of an opposite polarity to a initial polarity of voltage, which is used for an initial orientation of the liquid crystal panel, for the first frame period and supplies data voltages of the same polarity as the initial polarity for the second frame period.

In another aspect of the present invention, a method for driving a liquid crystal panel including ferroelectric liquid crystals of a half-V mode, the method includes supplying scan pulses to a plurality of gate lines of the liquid crystal panel, and selectively outputting positive data voltages and negative data voltages to a plurality of data lines of the liquid crystal panel whenever any one of the scan pulses is supplied to any one of the gate lines, wherein a first period, which the positive data voltages are supplied to the data lines, is longer than a second period, which the negative data voltages are supplied to the data lines.

In another aspect of the present invention, a method for driving a liquid crystal panel including ferroelectric liquid crystals of a half-V mode, the method includes driving a liquid crystal panel so that a first frame period, which the positive data voltages are supplied to the liquid crystal panel, becomes longer than a second frame period, which the negative data voltages are supplied to the liquid crystal panel.

In another aspect of the present invention, a method for driving a liquid crystal panel including ferroelectric liquid crystals of a half-V mode, the method includes driving a liquid crystal panel so that a first frame period becomes longer than a second frame period, wherein a driving circuit supplies data voltages of an opposite polarity to an initial polarity of voltage, which is used for an initial orientation of the liquid crystal panel, for the first frame period and supplies data voltages of the same polarity as the initial polarity for the second frame period.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of a liquid crystal display device illustrating characteristics of ferroelectric liquid crystals in a general half-V switching mode;

FIG. 2 is a graph illustrating an electric field transmitting curve of the ferroelectric liquid crystals in the half-V switching mode;

FIG. 3 is a circuit diagram of a liquid crystal display device in accordance with one embodiment of the present invention;

FIG. 4 is a view illustrating a driving waveform representing data voltages supplied according to frames in accordance with the present invention;

FIG. 5 is a view illustrating output waveforms of scan pulses in accordance with an embodiment of the present invention;

FIG. 6 is a view illustrating output waveforms of scan pulses in accordance with another embodiment of the present invention; and

FIG. 7 is a test graph illustrating effects of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a liquid crystal display device and a method for driving the same in accordance with one embodiment of the present invention will be described in more detail with reference to the accompanying drawings.

The liquid crystal display device and the method for driving the same in accordance with the present invention basically employ ferroelectric liquid crystals in a half-V switching mode. Therefore, the liquid crystal display device in accordance with the present invention has a rapid response time and a wide viewing angle as compared to a liquid crystal display device using nematic-based liquid crystals. Further, the liquid crystal display device in accordance with the present invention drives image data input from the outside in a frame inversion method, relatively increases a frame period for which positive data voltage which contributes to transmittance is applied, and relatively decreases a frame period for which negative data voltage which does not contribute to transmittance is applied. Thereby, the present invention may provide a liquid crystal display device in which the frame period contributing to transmittance is relatively lengthened to raise overall transmittance and thus to have high brightness.

Prior to detailed description of the embodiment of the present invention, ferroelectric liquid crystals in a half-V switching mode will be described first.

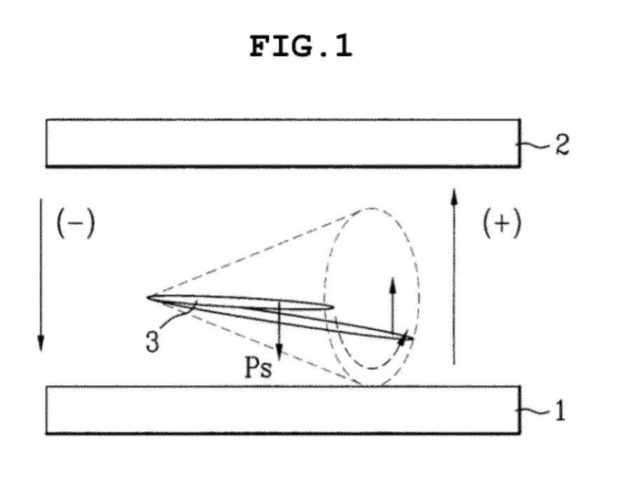

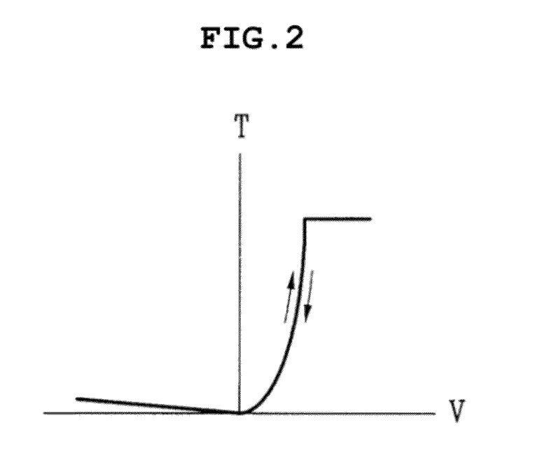

FIG. 1 is a sectional view illustrating characteristics of ferroelectric liquid crystals in a general half-V switching mode, and FIG. 2 is a graph illustrating an electric field transmitting curve of the ferroelectric liquid crystals in the half-V switching mode.

As shown in FIG. 1, a liquid crystal panel including ferroelectric liquid crystal molecules 3 in the half-V switching mode having mono-stable characteristics essentially goes through a phase transition process from a nematic (N*) phase to a smectic (SmC*) phase when a temperature is lowered from 100° C. During the phase transition process from the initial N* phase to the SmC* phase according to temperature change, an electric field of a DC component corresponding to driving saturation voltage of the liquid crystal molecules 3 is applied to a space between upper and lower plates 2 and 1, thereby initially orienting the liquid crystal molecules 3.

In more detail, when a negative (−) electric field is applied to the lower plate 1 during the phase transition process from the N* phase to the SmC* phase, spontaneous polarization (Ps) of the liquid crystal molecules 3 occurs and, simultaneously, the liquid crystal molecules 3 are disposed so that spontaneous polarization is oriented towards the lower plate 1 due to characteristics in which the direction of spontaneous polarization faces in the direction of the electric field, thus becoming mono-stable.

In such an initially oriented state, when a positive (+) electric field opposite to the component used in the initially oriented state is applied to the upper plate 2, the liquid crystal molecules 3 are rotated around a cone according to the magnitude of the electric field, thereby continuously transmitting light. However, in the case of the negative (−) electric field identical to the component used in the initially oriented state, the liquid crystal molecules 3 have the same position as the initially oriented position, and thus light is not transmitted. That is, the liquid crystal molecules 3 transmit light in the case of only voltage having polarity differing from the polarity of voltage used during initial orientation.

As shown in FIG. 2, when an orthogonal polarizer is disposed after initial orientation, data voltage (Vdata) transmittance of the ferroelectric liquid crystals has a half-V (HV) type, and for this reason, the ferroelectric liquid crystals is referred to as a half-V switching mode FLC.

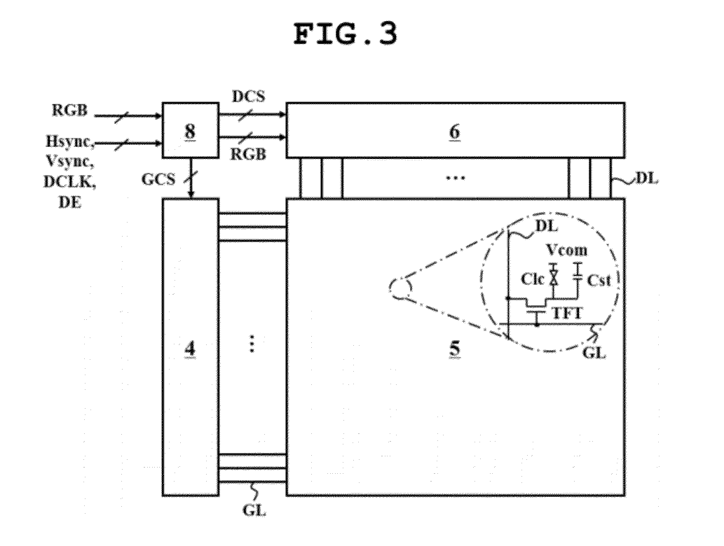

FIG. 3 is a circuit diagram of a liquid crystal display device in accordance with one embodiment of the present invention.

With reference to FIG. 3, the liquid crystal display device employing ferroelectric liquid crystals in a half-V switching mode in accordance with the embodiment of the present invention includes a liquid crystal panel 5, a gate driver 4, a data driver 6 and a timing controller 8 in the same manner as a general liquid crystal display device.

The liquid crystal panel 5 includes a first substrate and a second substrate opposite the first substrate. A plurality of gate lines (GL) and a plurality of data line (DL) which perpendicularly intersect each other to define pixel regions are formed on the first substrate. A color filter array and a common electrode to which common voltage (Vcom) is applied are formed on the second substrate. Such a liquid crystal panel 5 includes a ferroelectric liquid crystal layer between the first and second substrates. Here, the ferroelectric liquid crystal layer is formed of liquid crystals for a half-V switching mode.

Thin film transistors (hereinafter, referred to as TFTs) to drive liquid crystal cells (Clc) are formed at intersections of the plural gate lines (GL) and the plural data lines (DL). The TFTs supply data voltage (Vdata) provided from the data lines (DL) to the liquid crystal cells (Clc) in response to scan pulses provided from the gate lines (GL). Further, storage capacitors (Cst) to maintain pixel voltage of the liquid crystal cells (Clc) may be formed on the first substrate of the liquid crystal panel 5.

The color filter array corresponding to the pixel regions provided with the TFTs on the first substrate, a black matrix dividing the color filter array to shield the gate lines (GL) and the data lines (DL), and the common electrode are formed on the second substrate.

The timing controller 8 controls driving timing of the gate driver 4 and the data driver 6. For this purpose, the timing controller 8 generates a plurality of gate control signals (GCS) and a plurality of data control signals (DCS) using synchronization signals input from the outside, i.e., a horizontal synchronization signal (HSync), a vertical synchronization signal (VSync), a dot clock (DCLK) and a data enable signal (DE), and then outputs the plural gate control signals (GCS) and the plural data control signals (DCS). The timing controller 8 may output the plural gate control signals (GCS) and the plural data control signals (DCS) so that an odd frame period becomes longer than an even frame period.

The plural gate control signals (GCS) include a plurality of clock pulses having different phase differences, a gate start pulse (GSP) indicating start of driving of the gate driver 4, and a gate output enable (GOE) signal controlling an output period of the gate driver 4. Further, the plural data control signals (DCS) include a source output enable (SOE) signal controlling an output period of the data driver 6, a source start pulse (SSP) indicating start of data sampling, a source shift clock (SSC) controlling sampling timing of data, and a polarity control (POL) signal controlling voltage polarity of data.

The data driver 6 converts image data (RGB) into gamma voltage and supplies such gamma voltage as data voltage (Vdata) to the plural data lines (DL), in response to the plural data control signals (DCS) provided from the timing controller 8. Particularly, the data driver 6 is driven in a frame inversion method in which data voltage (Vdata) supplied to all the liquid crystal cells (Clc) is changed per frame cycle.

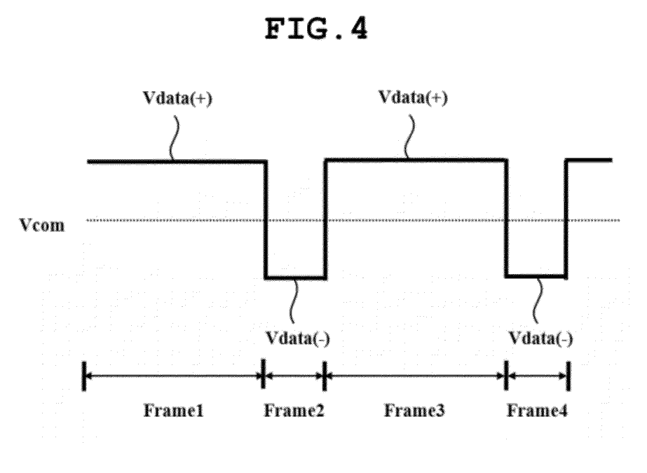

For example, the data driver 6 outputs positive data voltage Vdata(+) for the odd frame period and outputs negative data voltage Vdata(−) for the even frame period, as shown in FIG. 4.

As described above, in the case of the negative (−) electric field identical to the component used in the initially oriented state, the liquid crystals for the half-V switching mode have the same position as the initially oriented position. Therefore, for the even frame period for which the negative (−) electric field is applied to the liquid crystals for the half-V switching mode, light is not substantially transmitted and thus the even frame period causes lowering of brightness. In order to prevent such brightness lowering, the embodiment of the present invention sets the odd frame period, that is, a frame period which light is transmitted, to be longer than the even frame period, that is, a frame period which light is not transmitted.

Concretely, the data driver 6 outputs data voltage (Vdata) such that a period (for example, the odd frame period) for which positive (+) data voltage (Vdata) is applied is longer than a period (for example, the even frame period) for which positive (−) data voltage (Vdata) is applied. Of course, such operation of the data driver 6 is performed under control of the plural data control signals (DCS), such as the polarity control (POL) signal and the source output enable (SOE) signal et al. provided from the timing controller 8.

The gate driver 4 supplies scan pulses to the plural gate lines (GL) in response to the plural gate control signals (GCS) supplied from the timing controller 8. Particularly, the gate driver 4 outputs odd scan pulses for the odd frame period, and outputs even scan pulses, set to be different from the odd scan pulses, for the even frame period.

Concretely, the gate driver 4 outputs different scan pulses according to odd/even frames, as the length of the odd frame period is relatively lengthened and the length of the even frame period is relatively shortened.

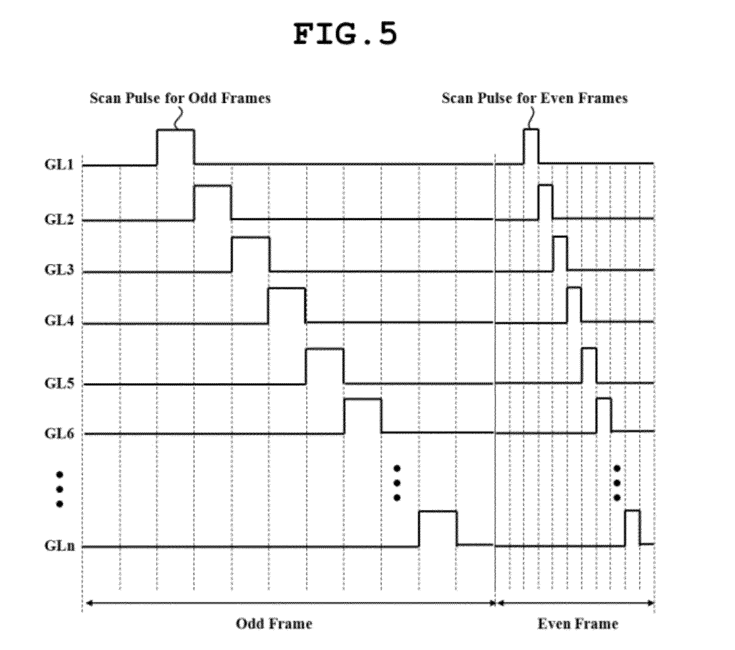

For example, the gate driver 4 sequentially supplies the odd scan pulses to the plural gate lines (GL) for the odd frame period and the even scan pulses to the plural gate lines (GL) for the even frame period, in the same manner as normal driving. However, as shown in FIG. 5, the gate driver 4 outputs the scan pulse for even frames having a pulse width set to be smaller than the pulse width of the scan pulse for odd frames, as the even frame period becomes shorter than the odd frame period. For example, if the pulse width of the scan pulse for odd frames is 10 ms, the pulse width of the scan pulse for even frames is set to 1 ms and thus the scan time of the even frames may be shortened to 1/10.

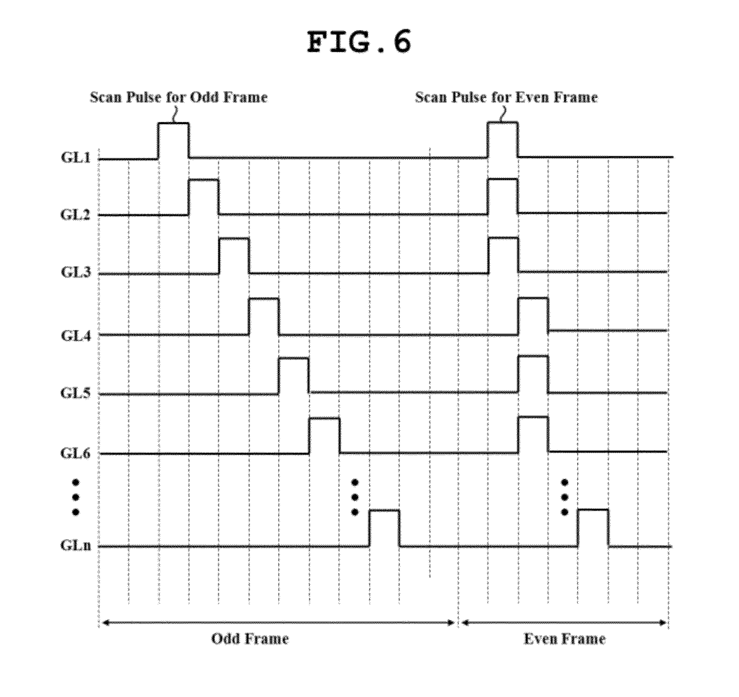

In another method, as shown in FIG. 6, the gate driver 4 sequentially supplies the scan pulses for odd frames to the plural gate lines (GL) for the odd frame period, in the same manner as normal driving. Further, the gate driver 4 may classifies the n plural gate lines (GL) into k (k<n) groups and sequentially supply the scan pulses for even frames to the k groups by a group unit for the even frame period. That is, the gate driver 4 sequentially drives the k gate line groups by the group unit and simultaneously drives the gate lines in each group for the even frame period. The width of the scan pulse for even frames is the same as the width of the scan pulse for odd frames. Although the scan pulse for odd frames and the scan pulse for even frames have the same pulse width set to 10 ms, the scan pulse for even frames is sequentially supplied to the k gate line groups by the group unit for the even frame period, thereby shortening the scan time to 1/k. The liquid crystals of the half-V switching mode does not transmit light by the negative data voltages for the even frame period.

Further, FIG. 6 exemplarily illustrates that three gate lines are set to one gate line group and the scan pulse for even frames is sequentially output to every gate line group, each of which includes three gate lines.

The embodiment of the present invention drives the gate driver 4 in the above method, thus being capable of shortening the scan time for the even frame period and lengthening the scan time for the odd frame period. Thereby, transmittance of the liquid crystals may be raised and brightness may be raised.

Further, in the embodiment, the even frame period is preferably shortened only up to the limit which can prevent degradation of characteristics of the liquid crystals.

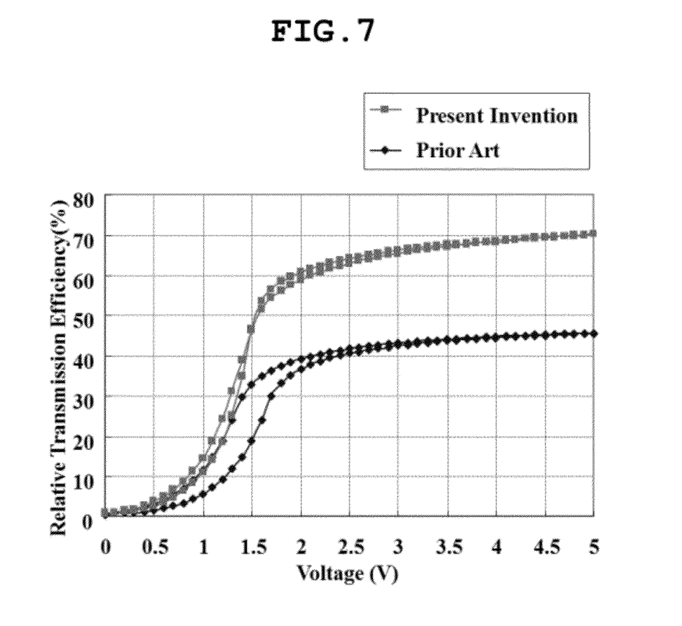

FIG. 7 is a test graph illustrating effects of the present invention.

Concretely, the graph shown in FIG. 7 represents a liquid crystal transmission efficiency curve of a conventional half-V FLC mode liquid crystal display device in which odd and even frame periods are set to be the same, and a liquid crystal transmission efficiency curve of a half-V FLC mode liquid crystal display device in accordance with the present invention in which odd and even frame periods are set to be different.

With reference to FIG. 7, it is understood that, while the conventional half-V FLC mode liquid crystal display device has transmission efficiency of 40˜50%, the half-V FLC mode liquid crystal display device in accordance with the present invention has transmission efficiency of 60˜70%. Therefore, the liquid crystal display device in accordance with the present invention has high transmittance of liquid crystals as compared to the conventional liquid crystal display device, and consequently has improved brightness. Further, the liquid crystal display device in accordance with the present invention omits optical members to improve brightness due to rising of brightness, thus having cost reduction effects.

As is apparent from the above description, the present invention relatively increases an frame period for which positive data voltage which contributes to transmittance is applied, and relatively decreases an frame period for which negative data voltage which does not contribute to transmittance is applied. Thereby, the present invention may provide a liquid crystal display device in which the frame period contributing to transmittance is relatively lengthened to raise overall transmittance and thus to have high brightness.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A liquid crystal display device comprising:
a liquid crystal panel including ferroelectric liquid crystals of a half-V mode;
a gate driver supplying scan pulses to a plurality of gate lines of the liquid crystal panel;
a data driver selectively outputting positive data voltages and negative data voltages to a plurality of data lines of the liquid crystal panel; and
a timing controller outputting a plurality of control signals to control the gate driver and the data driver,
wherein the timing controller outputs the plurality of control signals so that a first period, which the positive data voltages are supplied to the data lines, becomes longer than a second period, which the negative data voltages are supplied to the data lines.

2. The liquid crystal display device according to claim 1, wherein the gate driver outputs a first scan pulse for the first period, and outputs a second scan pulse, which is set to be different from the first scan pulse, for the second period.

3. The liquid crystal display device according to claim 2, wherein the gate driver sequentially supplies the first scan pulses to the plurality of gate lines for the period and sequentially supplies the second scan pulses to the plurality of gate lines for the second period,
wherein a pulse width of the second scan pulse is smaller than a pulse width of the first scan pulse.

4. The liquid crystal display device according to claim 2, wherein the gate driver:
sequentially supplies the first scan pulses to the plurality of gate lines for the first period; and
classifies the plurality of gate lines into a plurality of gate line groups, and sequentially supplies the second scan pulses to the plurality of gate lines by a group unit for the second period,
wherein the a pulse width of the second scan pulse is the same as a pulse width of the first scan pulse.

5. The liquid crystal display device according to claim 1, wherein the data driver drives the data lines by a frame inversion method and the first period is an odd frame period and the second period is an even frame period.

6. The liquid crystal display device according to claim 1, wherein the liquid crystal panel transmits light when the positive data voltages are supplied and does not transmit light when the negative data voltages are supplied.

7. A liquid crystal display device comprising:
a liquid crystal panel including ferroelectric liquid crystals of a half-V mode; and
a driving circuit driving a liquid crystal panel so that a first frame period, which the positive data voltages are supplied to the liquid crystal panel, becomes longer than a second frame period, which the negative data voltages are supplied to the liquid crystal panel.

8. A liquid crystal display device comprising:
a liquid crystal panel including ferroelectric liquid crystals of a half-V mode; and
a driving circuit driving a liquid crystal panel so that a first frame period becomes longer than a second frame period,
wherein the driving circuit supplies data voltages of an opposite polarity to an initial polarity of voltage, which is used for an initial orientation of the liquid crystal panel, for the first frame period and supplies data voltages of the same polarity as the initial polarity for the second frame period.

9. A method for driving a liquid crystal panel including ferroelectric liquid crystals of a half-V mode, the method comprising:
supplying scan pulses to a plurality of gate lines of the liquid crystal panel; and
selectively outputting positive data voltages and negative data voltages to a plurality of data lines of the liquid crystal panel whenever any one of the scan pulses is supplied to any one of the gate lines,
wherein a first period, which the positive data voltages are supplied to the data lines, is longer than a second period, which the negative data voltages are supplied to the data lines.

10. The method according to claim 9, wherein the supply of the scan pulses includes:
outputting a first scan pulse for the first period; and
outputting a second scan pulse, which is set to be different from the first scan pulse, for the second period.

11. The method according to claim 10, wherein the supply of the scan pulses includes:
sequentially supplying the first scan pulses to the plurality of gate lines for the first period; and
sequentially supplying the second scan pulses to the plurality of gate lines for the second period,
wherein a pulse width of the second scan pulse is smaller than a pulse width of the first scan pulse.

12. The method according to claim 10, wherein the supply of the scan pulses includes:
sequentially supplying the first scan pulses to the plurality of gate lines for the first period; and
classifying the plurality of gate lines into a plurality of gate line groups, and sequentially supplying the second scan pulses to the plurality of gate lines by a group unit for the second period,
wherein the a pulse width of the second scan pulse is the same as a pulse width of the first scan pulse.

13. The method according to claim 9, wherein the data lines are driven by a frame inversion method and the first period is an odd frame period and the second period is an even frame period.

14. The method according to claim 9, wherein the liquid crystal panel transmits light when the positive data voltages are supplied and does not transmit light when the negative data voltages are supplied.

15. A method for driving a liquid crystal panel including ferroelectric liquid crystals of a half-V mode, the method comprising;
driving a liquid crystal panel so that a first frame period, which the positive data voltages are supplied to the liquid crystal panel, becomes longer than a second frame period, which the negative data voltages are supplied to the liquid crystal panel.

16. A method for driving a liquid crystal panel including ferroelectric liquid crystals of a half-V mode, the method comprising;
driving a liquid crystal panel so that a first frame period becomes longer than a second frame period,
wherein a driving circuit supplies data voltages of an opposite polarity to an initial polarity of voltage, which is used for an initial orientation of the liquid crystal panel, for the first frame period and supplies data voltages of the same polarity as the initial polarity for the second frame period.
